(19) United States
(12) Patent Application Publication
(10) Pub. No.: US 2023/0305578 A1
(43) Pub. Date: Sep. 28, 2023

(54) METHOD AND SYSTEM FOR CONTROLLING A FLEET OF AUTONOMOUS VEHICLES FOR RIDESHARING

(71) Applicant: National Electric Vehicle Sweden AB, Trollhättan (SE)

(72) Inventors: Karin Melin, Vargön (SE); Anna Haupt, Nacka (SE); Siri Hargelius, Göteborg (SE); James Hildebrand, Linköping (SE); Felix Andlauer, Trollhättan (SE); Johan Ewerlöf, Mariestad (SE); Ivan Machado, Trollhättan (SE); Johan Adriansson, Trollhättan (SE); Mattias Klein, Vänersborg (SE); Vikram Murthy, Trollhättan (SE); David Stephenson, Sjuntorp (SE); Gustav Forsdahl, Frändefors (SE)

(21) Appl. No.: 18/013,040

(22) PCT Filed: Jun. 28, 2021
(86) PCT No.: PCT/SE2021/050636

§ 371 Date: Dec. 27, 2022

(30) Foreign Application Priority Data
Jun. 30, 2020 (SE) 2050793-5

(51) Int. Cl. G05D 1/02; B60N 2/90

(52) U.S. Cl. CPC G05D 1/0291; B60N 2/91; G05D 2201/0212

(57) ABSTRACT

The invention herein is a method and system for controlling a fleet of autonomous vehicles (300) for ridesharing, wherein the method comprising the steps of: receiving a request (S1) from a first user or group of users for pick-up by an autonomous vehicle out of said fleet of vehicles (300), said user request further comprising a privacy setting, controlling the state of a privacy barrier device (310a, 310b) of a first autonomous vehicle (301) according to said privacy setting, and controlling said first autonomous vehicle (301) to pick up said first user or group of users.

### TECHNICAL FIELD OF THE INVENTION

The invention relates to method and system for controlling a fleet of autonomous vehicle for ridesharing. Especially for controlling a fleet of autonomous vehicles wherein at least one vehicle comprises a privacy barrier device.

### BACKGROUND

Autonomous vehicles provide more resource efficient, time efficient and safe means of personal transportation compared to conventional vehicles. As the need for a human driver of each vehicle is eliminated, a fleet of autonomous vehicles may be operated efficiently and fully automatically to shuttle passengers to their desired locations.

Existing solutions for personal transport using a fleet of autonomous vehicles involves vehicles similar to conventional cars, configured with autonomous drive capability and often also electrical means of propulsion. These solutions further involve a communications interface, allowing users to book an autonomous vehicle for pick-up at a start position and drop-off at a target position. Following a user booking of a vehicle the autonomous vehicle will arrive at the start position, allow the user to enter the vehicle, navigate to the target location and allow the user to exit, thus completing the shuttle instance. If a second user simultaneously issues a second shuttle booking the communications interface will issue a second autonomous vehicle to serve the second shuttle request.

A problem with existing solutions is that while an autonomous vehicle serves a shuttle booking for a user it may not simultaneously serve a second user. As daily commuting involves a large portion of individual single travelers, as opposed to groups of e.g. 4 travelers who could occupy every seat of an autonomous car, existing autonomous shuttle solutions suffers from poor utilization of the total seat capacity of the total fleet of vehicles.

### SUMMARY OF THE INVENTION

Despite the solutions discussed the above, there is a need for an improved method and an improved system for controlling a fleet of autonomous vehicles for ridesharing which enables an increased utilization ratio and overcomes the shortcomings of previous solutions. It is an object of the present invention to provide such a method for controlling a fleet of autonomous vehicles which makes it possible to increase the utilization ratio.

The invention is defined by the appended independent claims, with embodiments being set forth in the appended dependent claims, in the following description, and in the drawings.

The invention is based on the inventors' realization that increasing the experienced personal space is a key fact for converting users that prefer riding private vehicles into sharing the ride with other users.

According to a first aspect of the inventive concept, there is provided a method for controlling a fleet of autonomous vehicles for ridesharing, wherein the method comprising the steps of:

receiving a request from a first user or group of users for pick-up by an autonomous vehicle out of said fleet of vehicles, said user request further comprising a privacy setting, controlling the state of a privacy barrier device of a first autonomous vehicle according to said privacy setting, and controlling said first autonomous vehicle to pick up said first user or group of users.

The term user is used synonymously with the term passenger in parts of this application. A user may also be referred to as a passenger when the user has entered a vehicle.

In the context of this application a privacy barrier device is interpreted as any device which is adapted to increase the experienced personal space for a passenger. The personal space is important to inviolate personality, individual's independence and to protect personal dignity & integrity, while travelling in a shared mobility. The inventors' have realized that providing personal space for the user is one of the most important aspects of shared mobility, private car-owners are to convert into ride sharing behavior. The privacy barrier may provide
Bodily privacy—Protection of our physical selves against invasive procedures. (Body odor or Smell; Physical Harassment; Ogling at co-passengers; Intentional or unintentional touch; Taking unwarranted pictures or video; Verbal Harassment)
Privacy of communication—Security and privacy of data during e.g. phone calls or Staring at Mobiles/Laptops.
Territorial privacy—Setting limits on intrusion into different seating zones, e.g. “Manspreading”—sitting with your legs slightly too far apart; Personal Space to empty pockets (keys/phones etc.) without a worrying them to be stolen; prevent people putting their feet on the seats)

Thus, a privacy barrier may provide visual, physical and/or acoustic privacy.

In one example, a privacy barrier may restrict sight of eye between passengers or passenger areas of the same vehicle. A privacy barrier device may be arranged so as to create a separate space for each passenger area or seat. Meaning that the privacy barrier device, the interior of the vehicle and a door of the vehicle may create an individual private space for one passenger or a group of passengers.

The privacy barrier device is controllable such that its state may be changed. For instance, the privacy barrier device may be in a private state in which the privacy barrier device restricts at least partly the sight of eye between passengers or passenger areas. The privacy barrier device may further be in a non-private state in which the privacy barrier device is adapted to not restrict sight of eye between passengers or passenger areas. Additionally, the privacy barrier device may in the private state further be adapted to restrict the transmission of sound, heat or vibrations between passengers or passenger areas so as to provide any type of privacy mentioned in the above.

With a privacy barrier in the private state, a passenger or group of passengers in a passenger area may enjoy privacy from a different passenger or group of passengers in a different passenger area of the same vehicle. In the non-private state, the privacy barrier device on the contrary allows a passenger or group of passengers in a passenger area to interact with a different passenger or group of passengers in a different passenger area of the same vehicle.

The present invention is at least partly based on the understanding that one inhibiting factor of increased capacity utilization of autonomous vehicles for ridesharing is the lack of privacy between users traveling together in the same vehicle. By allowing a user to include a privacy setting in the request for pick-up and controlling a privacy barrier device accordingly, the user may thereby allocate only the space he or she desires, while still having the desired level of privacy. In conventional autonomous ride sharing applications one whole vehicle would be allocated for a lone passenger requiring privacy. With the invention, multiple passengers may travel in the same vehicle with maintained privacy. Two passengers may for example travel with the same vehicle without ever seeing, hearing or being aware of each other.

An additional benefit of the invention lies in that the privacy barrier device is controllable and may change between its private and non-private state. Thus, the privacy barrier device of the autonomous vehicles may be in a non-private state allowing passengers of different passenger areas to interact. Which is suitable when groups of users are traveling together. The invention provides a method of tailoring the autonomous vehicle after user demand.

In an embodiment of the invention the method further comprises the step of: selecting said first autonomous vehicle out of said fleet of autonomous vehicles, based on at least one pick-up suitability criterion.

Different pick-up suitability criterion may be determined for each vehicle in a fleet of vehicles and may e.g. be how long the user has to wait for pick-up and how long the vehicle has to travel to pick up the user. By selecting the first autonomous vehicle from the fleet of autonomous vehicles based on a pick-up suitability criterion the first autonomous vehicle may be a suitable, or even the most suitable, vehicle for pick-up of the user. For instance, if the user or group of users has specified a private privacy setting in the request for pick-up, one pick-up suitability criterion may be whether the first vehicle may accommodate the user or group of users as passengers which are isolated from potential other passengers of the first autonomous vehicle.

In one embodiment, the pick-up criterion is that the selected vehicle should be capable of controlling the state of the privacy barrier into the desired state. Hereby, the user method or system may be capable of providing a vehicle that fulfills the user's request in terms of privacy state.

In one embodiment, the pick-up criterion is a combination of the time to possible pick up and whether or not a selected vehicle is capable of controlling the state of the privacy barrier into the desired state. Hereby, the user method or system may be capable of providing a vehicle that balances the interest of timely pick-up or waiting and that the vehicle fulfills the user's request in terms of privacy state.

In one embodiment, the user may weight different criteria, such as (i) the time to possible pick up and whether, (ii) and/or not a selected vehicle is capable of controlling the state of the privacy barrier into the desired state, (iii) and/or the size or style of vehicle. Hereby, the user may say e.g. the privacy status is crucial to selection of vehicle, or that the user is ready to wait e.g. 5, or 20 minutes extra with pick-up to get the preferred privacy status.

In a further embodiment of the step of controlling the state of said privacy barrier device of said first autonomous vehicle occurs prior to pick-up of said user or group of users.

By preemptively controlling the state of a privacy barrier device before the user is picked up the privacy of the user may be enhanced even when the user enters the vehicle. Additionally, by controlling the privacy barrier device before picking up a user the user will immediately be accustomed to the assigned passenger area as no privacy barrier may be controlled during the ride

In some embodiments of the present invention the method further comprises the steps of:

receiving a second request from a second user or group of users for pick-up by an autonomous vehicle, said second user request further comprising a privacy setting,

determining if pick up of said second user or group of users with said first autonomous vehicle is possible, based on at least one pick-up suitability criterion, if pick up of said second user or group of users with said first vehicle is possible,

picking up said second user or group of users with said first autonomous vehicle.

The first user or group of users traveling with the vehicle may overlap with the second user or group of users traveling with the vehicle. Determining that pick-up is possible of the second user or group of users based on one pick-up suitability criterion may including determining that the privacy setting of the first and second users pick-up request are compatible, meaning that the at least one privacy barrier of the first vehicle may be controlled such that both the first and second user or group of users may travel with their respective privacy setting. The method may include, if pick-up with the first autonomous vehicle is not possible, the step of determining that pick-up with a second autonomous vehicle is possible and controlling the second vehicle to pick up the second user.

A benefit of this embodiment is that the capacity utilization ratio of the first vehicle is increased as both the first and second user are picked up by the vehicle. The first user may be ensured privacy from other users entering or traveling in the same vehicle, without allocating the entire available passenger area of the vehicle.

In embodiments of the present invention the first and said second user request each comprises a requested drop-off location, said method further comprising the steps of:

dropping off the first and second user or group of users at said respective drop-off location with said first autonomous vehicle,

changing the order in which said first, and second user or group of users is picked up and dropped off such that a travel time delay for each of the first and second user or group of users is below a predetermined threshold time.

The travel time delay is the expected additional travel time compared to the expected travel time for the first or second user or group of users to reach their respective drop off location. Having determined that the first autonomous vehicle may pick up and drop off the first and second user or group of users the route and/or schedule and/or order for performing these tasks may be optimized so as to make the travel time for each user as short as possible and/or make the total travel distance for the vehicle as short as possible. By changing the order in which the first and second user is picked up or dropped off time and resources may be conserved accordingly. Additionally, the predetermined threshold time may be determined directly by the user. For instance, a user may define a relaxed delay constraint in the pick-up request being indicative of that he or she may tolerate a delayed pick-up and/or drop-off. In case one of the first and second user has specified a relaxed delay constraint in their pick-up request the method may accordingly prioritize the pick-up request of the other user.

In an alternative embodiment of the invention said first and said second user request each comprises a requested drop-off location and wherein said privacy barrier device in a non-private state is traversable by a passenger moving from a first passenger area to a second passenger area, wherein said method further comprises the steps of:

dropping off the first and second user or group of users at said respective drop-off location with said first autonomous vehicle,

changing the order in which said first and second user or group of users is picked up and dropped off such that said first and second user or group of users enters and exits said autonomous vehicle on the curbside.

A privacy barrier device which is traversable in the non-private state is to be interpreted as a privacy barrier device which a user may slide over or move around so as to move from one passenger area to another passenger area. For instance, the privacy barrier device may be integrated into a middle seat between a first and second seat. In the non-private state, a first user may traverse the privacy barrier device in the middle seat and move from the first seat to the second seat, e.g. as he or she would have done if the middle seat was a conventional middle seat of the back seat row in a car. The privacy barrier device may then be controlled to initiate its private state such that the first user in the second seat is in a private area. A second user may then enter the vehicle and occupy the first seat without the first and second users being aware of, seeing or hearing each other.

With at least one traversable privacy barrier device the order in which users are picked up and dropped off may be changed so that each passenger enters or exits the vehicle on a particular side of the vehicle, preferably the curbside. The invention thus minimizes risk by avoiding users moving on the roadside of the vehicle, where there is a risk of collision with other traffic.

A simple use case example of this situation is making sure that a long-distance traveler is picked up first, from the curbside, and enters into a curbside passenger area. The long-distance traveler is instructed to traverse a privacy barrier device and take a seat in a passenger area which does not include a door on to the curbside. The privacy barrier device is then controlled to its private state and the long-distance traveler enjoys his or her privacy. One or multiple consecutive other users may then, on different occasions, enter and exit the curbside passenger area and complete their respective journeys. By changing the order on which passengers are picked up or dropped off the method may assure that the curbside passenger is empty once the long-distance traveler reaches the drop-off location, the privacy barrier may then enter its non-private state, allowing the long-distance traveler to traverse the barrier to the curbside passenger area and exit the vehicle on the curbside.

In some embodiments of the invention the method further comprises the step of: receiving, by said first autonomous vehicle an en route request from a user inside or in the proximity of said first autonomous vehicle, wherein said en route request comprises a privacy barrier setting.

An en route request is communicated from the user directly to the autonomous vehicle once a user is inside or close enough to the vehicle. The user may issue such an en route request via suitable short-range communication means, such as Bluetooth, WI-FI or voice command. An en route request may comprise an en route privacy setting which may be a request to control the privacy barrier device by altering the state of the privacy barrier device. If no second user is affected by the en route privacy barrier change, the privacy barrier is controlled as per the en route request. If a second user is affected, the second user may be prompted to accept a proposed change of the privacy barrier state, thus ensuring mutual acceptance from users being affected by an en route privacy barrier state change.

Additionally, short-range communication directly with the autonomous vehicle saves a user from using mobile data and decreases communication latencies.

Alternatively, an en route request may be submitted by a user completely analogously to how a pick-up request is submitted.

In some embodiments of the invention the method further comprises the step of: determining an emergency state of the first autonomous vehicle and retracting said privacy barrier to facilitate exiting of the vehicle. Hereby, if the vehicle is in an accident so that the passenger(s) need to exit the vehicle, the privacy barrier may be retracted to facilitate exiting the vehicle.

In some embodiments of the invention the method further comprises the step of: determining if the force exerted onto the privacy barrier for changing the position of the privacy barrier exceeds a predetermined value, stopping the control of the barrier. Hereby, the privacy barrier becomes pinch safe. This is especially desired if the state to the privacy barrier is moved when the vehicle is not empty. For example, if the privacy barrier is moved while there is a passenger or any personal belongings in the vehicle that could get hurt/damages by the privacy barrier. Further, a force determination function that stops the privacy screen movement could safeguard the motor driving the privacy barrier from overloading and brake.

According to a second aspect of the invention there is provided a system for controlling a fleet of autonomous vehicles for ridesharing, said system comprising: a remote server adapted to receive a request from a first user or group of users for pick-up by an autonomous vehicle out of said fleet of vehicles, said user request further comprising a privacy setting, and a first autonomous vehicle of said fleet of autonomous vehicles comprising a privacy barrier device adapted to be remotely controlled from said remote server according to said privacy setting, said first autonomous vehicle being further adapted to pick up said first user or group of users.

The invention according to the second aspect features the same or equivalent embodiments and benefits as the invention according to the first aspect. Further, any functions described in relation to the method, may have corresponding structural features in the system.

The user may issue a request for pick-up via a suitable user device which is connected to the remote server via a mobile data connection. The remote server controls the incoming requests from users and assigns suitable autonomous vehicles to meet the pick-up requests of the users. Additionally, besides allocating suitable vehicles to their respective users the remote server further controls the privacy barrier devices of autonomous vehicles such that the privacy setting of each user request is considered when assigning the vehicles to the users.

In some embodiments of the invention the first autonomous vehicle further comprises at least two passenger areas separated by a clear area, and said privacy barrier device is adapted to, in a privacy state, extend into said clear area and, in a non-privacy state, retract outside of said clear area. Hereby, the privacy barrier has a dedicated area both in a retracted and in an extended status.

A privacy barrier device may be a sliding screen type privacy barrier device. Such a privacy barrier device may comprise a body portion with an opening, driving means arranged in the body portion and a screen, mechanically coupled to the driving means and adapted to move in and out of the opening in the body portion. Similar to how a car window slides in and out of the door of a car the privacy barrier device may be adapted to slide in and out of the body portion. The privacy barrier device of this type may be arranged such that the screen deploys in an upward direction from the floor of the vehicle towards the roof of the vehicle or in the opposite direction, such that the privacy barrier device deploys in a downwards direction, from the roof the vehicle towards the floor. Alternatively, the privacy barrier device may be arranged to deploy in the horizontal direction, either from the front of the vehicle towards the rear or vice versa.

The privacy barrier devices do not necessarily comprise a screen, sufficient privacy may be achieved with a barrier which is rolled out (as it extends into the clear area) or rolled in (as it is retracted out of the clear area). The barrier may be a bellows construction which is compressed and extended in the different privacy states. The barrier may be a curtain movable on rails. The barrier may be a construction of multiple plates, fastened to each other via hinges and extend/retract in a folding door fashion. The barrier may be in the shape of a fan with a plurality of fan elements adapted to rotate around a common fixation point.

In a third aspect of the invention there is provided a computer program product comprising code for performing, when run on a computer device, the steps of: receiving a request from a first user or group of users for pick-up by an autonomous vehicle out of said fleet of vehicles, said user request further comprising a privacy setting, controlling the state of a privacy barrier device of a first autonomous vehicle according to said privacy setting, and controlling said first autonomous vehicle to pick up said first user or group of users.

The invention according to the third aspect features the same or equivalent embodiments and benefits as the invention according to the first or second aspect. This aspect of the invention is basically to conduct the method steps by means of a software implemented into a product which can control the state of the privacy barrier from a remote server. Further, any functions described in relation to the method, may have corresponding structural features in the system.

It should be understood that this patent application includes the disclosure of a computer program having code for carrying out any step or functionality described in relation to the method and/or system for handling controlling a fleet of autonomous vehicles as described above. Further it should be understood that the computer readable medium may be one of a removable nonvolatile random access memory, a hard disk drive, a CD-ROM, a DVD-ROM, a USB memory, an SD memory card, or a similar computer readable medium known in the art (present and future). The present invention may be implemented using a combination of software and hardware elements.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing exemplary embodiments of the present invention, wherein:

FIG. 1 is a flow chart of a method according to embodiments of the present invention.

FIG. 2 is a flow chart of a method according to embodiments of the present invention.

FIG. 3 is a block diagram of a system for controlling a fleet of autonomous vehicles according to aspects of the invention.

FIG. 4 is a schematic view of a privacy barrier device in a non-privacy state according to embodiments of the invention.

FIG. 5 is a schematic view of a privacy barrier device in a privacy state according to embodiments of the invention.

### DETAILED DESCRIPTION

In the following detailed description, some embodiments of the present invention will be described. However, it is to be understood that features of the different embodiments are exchangeable between the embodiments and may be combined in different ways, unless anything else is specifically indicated. Even though in the following description, numerous details are set forth to provide a more thorough understanding of the present invention, it will be apparent to one skilled in the art that the present invention may be practiced without these details. In other instances, well known constructions or functions are not described in detail, so as not to obscure the present invention.

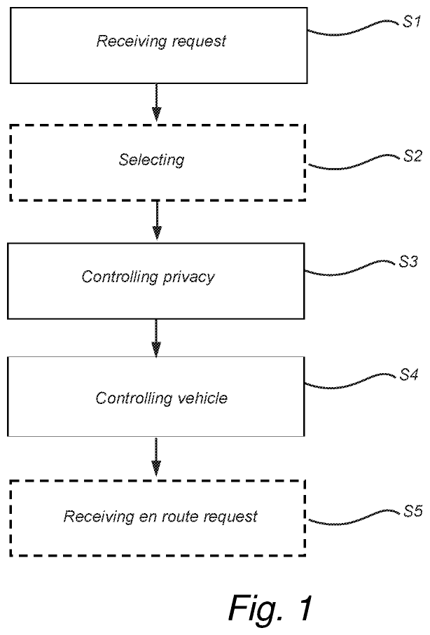

With reference to FIG. 1 there is illustrated a schematic flow chart describing a method according to some embodiments of the invention. At S1 a request for pick-up is received from a user or group of users. The request comprises a privacy setting specifying if the user wishes to travel privately. The request received at S1 may comprise further information parameters, such as a pick-up time, pick-up location (e.g. the current position of the user), number of passengers traveling together, drop-off time, drop-off location, time delay constraint tolerance level, a privacy/delay priority and a requested vehicle type.

In some embodiments, the request may also comprise a weighting factor for some or all of the provided information parameters. E.g. a used may state that the pick-up location is flexible within a set range, and/or that the privacy barrier setting is optional or required. Also, it may be possible for a user to put a maximum additional wait or maximum movement from pick up location in order to get a vehicle with the desired privacy setting.

In some exemplary embodiments the method may comprise the step S2 of selecting a first autonomous vehicle out of the vehicles included in the fleet of autonomous vehicles. The first autonomous vehicle may be selected as the most suitable vehicle for pick-up out of the vehicles present in the fleet. The most suitable vehicle may be determined by comparing at least one pick-up suitability criterion for at least some of the vehicles present in the vehicle fleet. Alternatively, for each vehicle at least two pick-up suitability criteria may be weighed against each other and combined to generate a total weighting point. The vehicle with the best, e.g. the highest total weighting point, may be deemed the most suitable and thereby selected at S2.

The pick-up suitability criterion may be chosen from a group comprising: distance to first user, ability to fulfil the privacy setting of the first user, delay constraints of the first user, priority constraints of the first user, pick-up request from another user or group of users either pending or en route, travel delay introduced for other users, delay constraints of other users and priority constraints of other users. Each vehicle is accredited weighting points for each suitability criterion, e.g. with positive values assigned preferable suitability criterions. For example, for each kilometre an autonomous vehicle has to travel before reaching a pick-up location or for each kilometre the route of the autonomous vehicle is extended to serve a pick-up request one negative weight point may be assigned. As a further example, if a vehicle may fulfil the privacy setting of a pick-up request ten weight points may be assigned, and on the contrary, if the privacy setting of the pick-up request may not be fulfilled ten negative weight points may be assigned. Moreover, the user may specify in the pick-up request a privacy/delay priority specifying if the user wishes to wait longer (e.g. by specifying a maximum wait time) to get picked up by a vehicle which may fulfil the privacy setting or if the user prioritises a sooner pick-up over a vehicle which fulfils the requested privacy setting.

In some embodiments a user may specify a relaxed delay constraint being indicative that he or she may accept a longer waiting time. A relaxed delay constraint may for example be set by specifying a maximum waiting time. For such requests the weighting points of pick up suitability criterion relating to the time it takes for the first vehicle reach the user may have their magnitude reduced. For instance, in the example above, each kilometer the first vehicle has to travel before reaching the user may only represent a half negative weighting point as opposed to one negative weighting point without the relaxed delay constraint. The most suitable vehicle may be selected as the vehicle with the highest sum of weight points for at least one pick-up suitability criterion.

After S1, or S2, the method may go to S3 which comprises controlling the privacy barrier device of first autonomous vehicle which has been assigned to serve the pick-up request. Alternatively, the method may go to S4 which comprises controlling the autonomous vehicle for pick-up before S3 or in parallel with S3.

Controlling the privacy barrier device in S3 may comprise sending a control signal to the first autonomous vehicle wherein the control signal comprises information indicating the correct state for fulfilling the privacy setting of the request. Also, controlling the autonomous vehicle in S4 may comprise sending pick-up location data to the vehicle. Due to the autonomous capabilities the autonomous vehicle may navigate safely through traffic to the pick-up location with minimal or no external control input.

In some exemplary embodiments, the state of the privacy barrier may be controlled after picking up the user. In such cases, the step of controlling the privacy barrier device may further comprise the sub-step of identifying that a user has safely entered the vehicle, and then controlling the state of the privacy barrier. In further embodiments of the invention the privacy barrier device may be controlled prior to picking up the user.

Some embodiments of the invention include a step S5 comprising receiving an en route request directly from the user, or via a remote server. An en route request comprises a privacy setting and S5 may further comprise a sub-step of determining if the privacy setting of the en route request is allowable. If the en route request is allowable the S5 may comprise a sub-step of controlling the state of the privacy barrier in accordance with the en route request. The sub-step of determining if privacy setting of the en route request is allowable may comprise determining if another user will be affected by the en route privacy setting. If no user is affected, the privacy setting of the en route request may be determined to be allowable. If another user will be affected by the en route privacy setting a further step of prompting the user which will be affected to agree/disagree with the en route privacy setting may be included. If the affected user disagrees the privacy setting of the en route request is determined to be not allowable. If the If the affected user agrees the privacy setting of the en route request is determined to be allowable.

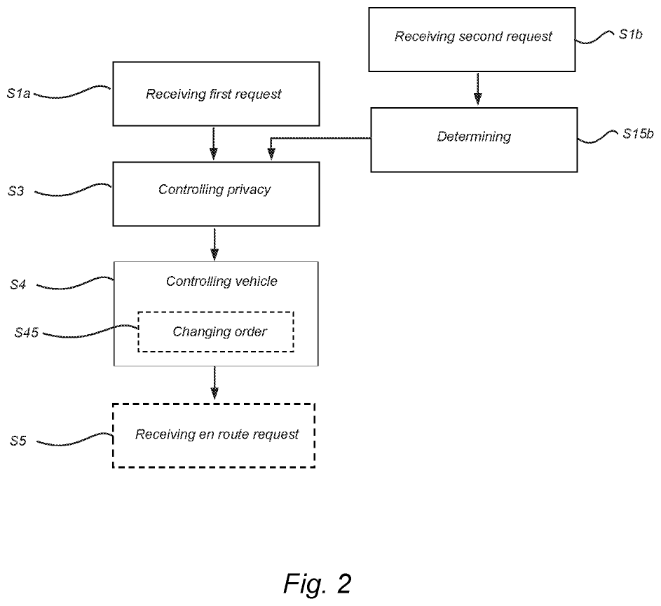

With reference to FIG. 2 there is illustrated a flow chart describing a method according to the present invention. At step S1a a first request for pick-up is received from a first user, the pick-up request comprises a privacy setting as in described in embodiments of the invention. At S3 the privacy barrier device of a first vehicle, assigned to pick up the first user is, is controlled such that the privacy barrier device is set to the state corresponding to the privacy setting of the first request.

At S4 the first autonomous vehicle is controlled to pick up the first user.

At S1b a second request of pick-up is received from a second user. The step of receiving a second user request is similar to S1 or S1a. After receiving a second user request for pick-up by a second user the method may go to S15b comprising determining if pick-up of the second user with the first vehicle autonomous vehicle is possible. If pick-up is possible S3 further comprises controlling a privacy barrier device of the first vehicle such that the privacy setting of the second user is fulfilled and S4 further comprises controlling the first autonomous vehicle to pick-up the second user. As further depicted in FIG. 2, S4 may comprise a sub-step S45 of changing the order in which the first and second user are picked up or dropped off. As previously described, the change of pick-up/drop-off order for the first and second user may be to minimize a travel time delay or enable that each user may enter and/or exit the vehicle on the curbside. In a further exemplary embodiment, the change of order in which the first and second user are picked-up or dropped-off may be to enable the autonomous vehicle to fulfil the privacy setting of each request. Furthermore, step S3 and S4 are interchangeable and may occur in any order or in parallel.

When referring to a change in the order in which the users are picked up and dropped off such a change may be in relation to any first pick-up/drop-off schedule. For instance, a first schedule for picking up and dropping of users may always be to pick up and drop off the user who made the earliest request and then pick up and drop off the second user, who made a later request. Such a schedule may introduce a long-time travel delay for the second user, who has to wait for the requested trip of the first user to finish. A change in pick-up/drop-off order may then be implemented such that e.g. the first user is picked up, then the second user is picked up, then the first user is dropped off and then the second user is dropped off wherein the total travel time delay for both users is smaller compared to the first schedule.

Additionally, some embodiments of the invention include a step S5 which comprises receiving by the vehicle an en route request from users inside or in close proximity to the vehicle. An en route request may be issued by any passenger of the first autonomous vehicle in accordance with other embodiments of the invention. An en route request comprises a privacy setting, and the allowability and handling of such an en route privacy setting was described in relation to step S5 of FIG. 1. It is understood that the other user referred to in combination to S5 of FIG. 1 is interchangeable with the second user of introduced in the embodiment depicted in FIG. 2. An en route request may be handled through direct communication with a vehicle control unit for controlling the privacy barrier. However, if handled locally, the vehicle control unit must also store any privacy setting data from all users or groups of users so as to only allow changes to the privacy setting that is approved by all users or group of users, as explained above. The en route control may in the alternative be handled directly from a mobile device of the user to the remote server 100 of fleet management system.

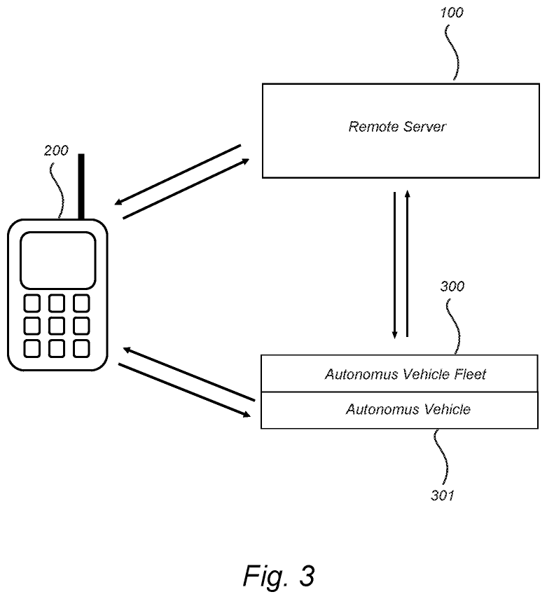

In FIG. 3 there is depicted a system for controlling a fleet of autonomous vehicles for ridesharing according to an aspect of the present invention. The system comprises a remote server 100 adapted to receive a request for pick-up by a user. The user may submit such a request via his or her user device 200. The request may be submitted to the remote server 100 and the remote server 100 may respond by sending a confirmation back to the user device 200. The remote server 100 is further adapted to control a fleet of autonomous vehicles 300. In some embodiments of the invention the remote server 100 is further adapted to select a first autonomous vehicle 301 to serve a particular user request, by evaluating at least one pick-up suitability criterion. Additionally, the remote server may be adapted to perform any of the steps: determining if pick-up is possible, changing the order in which users are picked up or dropped off to minimize a travel time delay or enable users to enter and exit the autonomous vehicle 301 on the curbside and controlling the autonomous vehicle 301 for drop-off according a received drop-off location.

Moreover, the short-range communication directly between the user or the user device 200 of the user and the autonomous vehicle 301 is also depicted in FIG. 3. The autonomous vehicle 301 which has been assigned to the user may receive directly from the user (e.g. as a voice command or by the user operating an input device located on or inside the autonomous vehicle 301) or via a user device 200 an en route request which comprises a privacy barrier setting.

The user device may be any device that is capable of receiving a request input from the user, transmitting the request to the remote server and/or directly to the vehicle, and receiving confirmation from the remote server and/or vehicle. Examples of such user devices are mobile phones, smart phones, wearables like watches or smart glasses, computers, tablets, gaming devices or any other device with the above-mentioned capabilities.

The system may further comprise sensors or detecting units, or being capable of receiving a signal from the vehicle control unit, that can determine an emergency state of the vehicle. An emergency state may for example be that a collision has occurred, the vehicle has run of the road, or that the vehicle is inoperable for any reason. Upon detection of such emergency state, the privacy barrier will be retracted to facilitate exiting of the vehicle. The retraction may be active with a motor retracting the barrier into the retracted position, or it can be passive, by decoupling the barrier from the motor, so that a user him/herself may push the barrier into the retracted position.

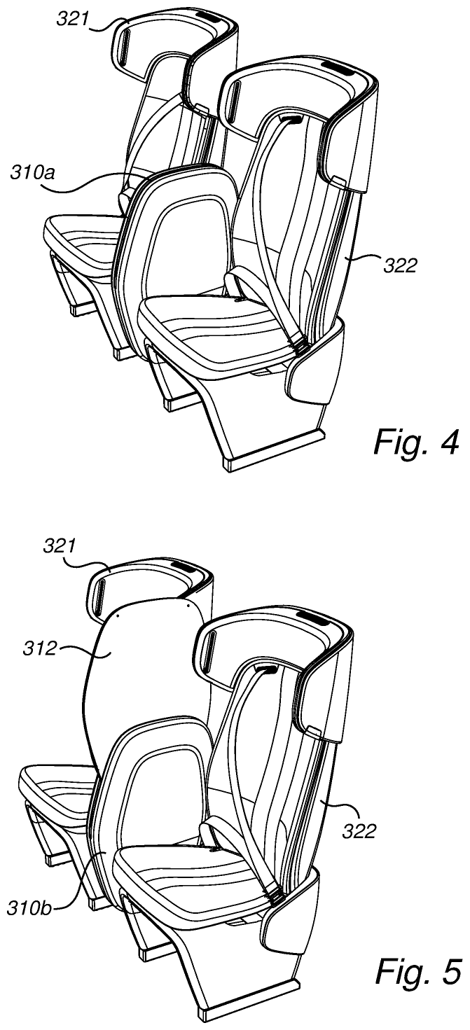

With reference to FIG. 4 and FIG. 5 there is illustrated an exemplary embodiment of a privacy barrier device 310a, 310b placed between two adjacent seats 321, 322. The privacy barrier device 310a in FIG. 4 is in a non-privacy state while the privacy barrier device 310b in FIG. 5 is in a private state. The privacy barrier device 310a, 310b depicted in FIG. 4 and FIG. 5 serves merely as an example, the privacy barrier device 310a, 310b may be larger, smaller, oriented differently or shaped in any suitable form.

The privacy barrier may be automatically moved between the positions by means of an actuator upon a control command from a control unit of the system. The actuator may be any type of force generating means, such as a motor, pneumatic- or hydraulic lever. The movement may be a sliding movement, which can either have two distinct positions, the non-private state as shown in FIG. 4 or the private state as shown in FIG. 5. It is also possible that the privacy barrier may have intermediate positions achieving different types of privacy, e.g. allowing eye-contact, but prohibiting touching or protecting belongings brought onto the vehicle by the passengers.

The privacy barrier device 310a, 310b may comprise means for pinch-protection, which stops or reverts extension of the barrier 312 in case a predetermined threshold force is exceeded for extending the barrier 312. In an exemplary embodiment the driving means of the privacy barrier device 310a, 310b comprises a sensor which detects the load of the driving means, should this load exceed a certain threshold value an anti-pinch state is determined, and the driving means stop and/or reverses. The predetermined threshold load may be an expected maximum load of extending the barrier 312 without any object obstructing the extension. Similarly, if there is a risk of pinching a user in the retracting state of the privacy barrier device 310a, 310b, an analogous anti-pinch feature may be included for hindering any from being pinched by a retracting barrier.

The privacy barriers may be designed to provide visibility of the environment, but still e.g. prohibit eye-contact between passengers. The visibility of the environment may either be achieved by clear sight lines to the environment, or by allowing light from the environment to pass through the barrier element. It is also possible to actively regenerate a picture of the environment onto the privacy barriers. By allowing the user to experience the environment despite the privacy barriers, the user may avoid getting motion sickness from riding the vehicle.

An autonomous vehicle may comprise more than one privacy barrier device 310a, 310b. The privacy barrier device 310a, 310b may be arranged between two passenger areas, wherein each passenger area comprises at least one passenger seat. In the exemplary embodiments shown in FIG. 4 and FIG. 5 the two seats 321, 322 may respectively constitute a passenger area. In one embodiment the autonomous vehicle is a conventional car-type autonomous vehicle with multiple rows of passenger seats. For example, the seats 321, 322 may constitute a row of seats in a conventional car-type autonomous vehicle. The privacy barrier device 310a, 310b may then be arranged between seats of the same row, e.g. as depicted in FIG. 4 and FIG. 5, and additionally or alternatively between two seats of different but adjacent rows.

In FIG. 4 a clear area is depicted right above the privacy barrier device 310a in its non-private state and in FIG. 5 it is illustrated how the privacy barrier device 310b in its private state extends into the clear area to restrict eye of sight between the two seats.

Alternatively, the clear area may comprise a third passenger area, such as a seat separating the other two passenger areas, or seats 321, 322, wherein the third passenger area is accessible by a user when the privacy barrier device 310a, 310b is in the non-privacy state 310a. The privacy barrier device 310a, 310b may be integrated in the interior of the vehicle. For example, the privacy barrier device 310a, 310b may be integrated into a seat such that when the privacy barrier device 310a, 310b is in its non-private state 310a an additional seat is available. Changing the state of the privacy barrier device 310a, 310b to the private state 310b makes the seat unavailable as the privacy barrier device 310a, 310b extends into a clear area which otherwise would have been occupied by a passenger.

The skilled person in the art realizes that the present invention by no means is limited to the embodiments described above. The features of the described embodiments may be combined in different ways, and many modifications and variations are possible within the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. Method for controlling a fleet of autonomous vehicles for ridesharing, said method comprising the steps of:
receiving a request from a first user or group of users for pick-up by an autonomous vehicle out of said fleet of vehicles, said user request further comprising a privacy setting,
controlling the state of a privacy barrier device of a first autonomous vehicle according to said privacy setting, and
controlling said first autonomous vehicle to pick up said first user or group of users.

2. Method for controlling a fleet of autonomous vehicles for ridesharing as in claim 1, wherein said method further comprises the step of:
selecting said first autonomous vehicle out of said fleet of autonomous vehicles, based on at least one pick-up suitability criterion.

3. Method for controlling a fleet of autonomous vehicles for ridesharing as in claim 1, wherein said step of controlling the state of said privacy barrier device of said first autonomous vehicle occurs prior to pick-up of said user or group of users.

4. Method for controlling a fleet of autonomous vehicles for ridesharing as in claim 1, wherein said method further comprises the steps of:
receiving a second request from a second user or group of users for pick-up by an autonomous vehicle, said second user request further comprising a privacy setting,
determining if pick up of said second user or group of users with said first autonomous vehicle is possible, based on at least one pick-up suitability criterion, if pick up of said second user or group of users with said first vehicle is possible,
picking up said second user or group of users with said first autonomous vehicle.

5. Method for controlling a fleet of autonomous vehicles for ridesharing as in claim 4, wherein said first and said second user request each comprises a requested drop-off location, said method further comprising the steps of:
dropping off the first and second user or group of users at said respective drop-off location with said first autonomous vehicle,
changing the order in which said first, and second user or group of users is picked up and dropped off such that a travel time delay for each of the first and second user or group of users is below a predetermined threshold time.

6. Method for controlling a fleet of autonomous vehicles for ridesharing as in claim 4, wherein said first and said second user request each comprises a requested drop-off location and wherein said privacy barrier device in a non-private state is traversable by a passenger moving from a first passenger area to a second passenger area, wherein said method further comprises the steps of:
dropping off the first and second user or group of users at said respective drop-off location with said first autonomous vehicle,
changing the order in which said first and second user or group of users is picked up and dropped off such that said first and second user or group of users enters and exits said autonomous vehicle on the curbside.

7. Method for controlling a fleet of autonomous vehicles for ridesharing as in claim 1, wherein said method further comprises the step of:
receiving, by said first autonomous vehicle an en-route request from a user inside or in the proximity of said first autonomous vehicle, wherein said en-route request comprises a privacy barrier setting.

8. Method for controlling a fleet of autonomous vehicles for ridesharing as in claim 1, wherein said method further comprises the step of:
determining an emergency state of the first autonomous vehicle and retracting said privacy barrier to facilitate exiting of the vehicle.

9. Method for controlling a fleet of autonomous vehicles for ridesharing as in claim 1, wherein said method further comprises the step of:
determining if the force exerted onto the privacy barrier for changing the position of the privacy barrier exceeds a predetermined value, stopping the control of the barrier.

10. A system for controlling a fleet of autonomous vehicles for ridesharing, said system comprising:
a remote server adapted to receive a request from a first user or group of users for pick-up by an autonomous vehicle out of said fleet of vehicles, said user request further comprising a privacy setting, and
a first autonomous vehicle of said fleet of autonomous vehicles comprising a privacy barrier device adapted to be remotely controlled from said remote server according to said privacy setting, said first autonomous vehicle being further adapted to pick up said first user or group of users.

11. A system for controlling a fleet of autonomous vehicles for ridesharing as in claim 10, wherein said first autonomous vehicle further comprises at least two passenger areas separated by a clear area, and
said privacy barrier device is adapted to, in a privacy state, extend into said clear area and, in a non-privacy state, retract outside of said clear area.

12. A computer program product comprising code for performing, when run on a computer device, the steps of:
receiving a request from a first user or group of users for pick-up by an autonomous vehicle out of said fleet of vehicles, said user request further comprising a privacy setting,
controlling the state of a privacy barrier device of a first autonomous vehicle according to said privacy setting, and
controlling said first autonomous vehicle to pick up said first user or group of users.
